(19) United States
(12) Patent Application Publication
(10) Pub. No.: US 2013/0067544 A1
(43) Pub. Date: Mar. 14, 2013

(54) SYSTEM FOR AUTHENTICATION MANAGEMENT OF A SENSOR NODE HAVING A SUBSCRIPTION PROCESSING FUNCTION, AND A METHOD FOR OPERATING THE SYSTEM

(71) Applicants: Gwang Hoon Kwark, Busan (KR); Tae Hoon Kim, Busan (KR); Byung Kwon Park, Busan (KR); Hyung Rim Choi, Busan (KR)

(72) Inventors: Gwang Hoon Kwark, Busan (KR); Tae Hoon Kim, Busan (KR); Byung Kwon Park, Busan (KR); Hyung Rim Choi, Busan (KR)

(73) Assignee: Dong-A University Research Foundation for Industry-Acacemy Cooperation, Busan (KR)

(21) Appl. No.: 13/699,332

(22) PCT Filed: May 24, 2011
(86) PCT No.: PCT/KR2011/003802

§ 371 Date: Nov. 21, 2012

(30) Foreign Application Priority Data
May 25, 2010 (KR) 10-2010-0048427

(51) Int. Cl. H04L 9/32

(52) U.S. Cl. 726/4; 726/3

(57) ABSTRACT

The present invention relates to a system for authentication management of a sensor node having a subscription processing function, and a method for operating the system. Upon receiving information about a sensor node allocated with an IP address, the system supports the access of only authorized user equipment to a corresponding sensor node, which blocking any direct access of unauthorized user equipment to the sensor node, thereby strengthening the security of the sensor node. According to the present invention, a relay server receives subscription information from user equipment. The relay server checks permission validity of corresponding user equipment. If the user equipment has a valid permission, the relay server transmits the subscription information to a sensor node, and transmits subscription acceptance information to the user equipment. Then the sensor node transmits the collected and stored information to the user equipment having a valid permission.

### TECHNICAL FIELD

The present invention relates to sensor node management and, more particularly, to a system for authentication management of a sensor node having a subscription processing function that allows only an authorized user equipment to access the sensor node by operating a relay server, and a method for operating the system.

### BACKGROUND ART

When a sensor node that collects information and a plurality of user equipments capable of accessing the sensor node to receive information are present, the plurality of user equipments can transmit subscription information for requesting the sensor node to provide collected information to the sensor node. Then, the sensor node can transmit the collected information to the user equipments depending on the subscription information.

According to this subscription function, the plurality of user equipments can access a single sensor node, register information thereof in the sensor node, input a specific time at which each of the user equipments wants to receive specific information and type of the specific information, and receive the information at the specific time. In addition, the subscription function supports correction of information stored in a sensor node. Furthermore, according to the subscription function, a user equipment can set a threshold value and receive warning information when specific information is generated, and information and time set by the user equipment can be changed even when a corresponding sensor node is remotely located.

In this case, the sensor node is designed to transmit collected information to a user equipment that has transmitted subscription information without authentication or authorization of the user equipment, and thus an additional configuration for authentication of the user equipment is required. If authentication is not considered, a user equipment may directly access a specific sensor node only using IP information of the specific sensor node to periodically receive information of the sensor node through subscription. Accordingly, an unauthorized user equipment can illegally use information collected by the sensor node by communicating with the sensor node.

To solve this problem, there has been proposed a method of directly coordinating an authentication tool with a client application program and a server application program at a program source level in a program development stage in a server-client computing environment. However, a sensor node having a limited resource is difficult to accept the server application program and data according to this method.

### DETAILED DESCRIPTION OF THE INVENTION

### Technical Problems

An object of the present invention devised to solve the problem lies in a system for authentication management of a sensor node having a subscription processing function, in which a relay server manages the sensor node for the subscription function of the sensor node, determines whether to authenticate a user equipment when the user equipment requests subscription to the relay node without directly accessing the sensor node, transmits permission information to the sensor node, and transmits the result of transmission of the permission information to the sensor node to the user equipment such that only an authorized user equipment can be provided with information of the sensor node, and a method for operating the system.

### Technical Solutions

To accomplish the object of the present invention, there is provided a system for authentication management of a sensor node having a subscription processing function, which includes at least one sensor node, at least one user equipment, and a relay server. The sensor node collects information using a sensor, and the user equipment receives information from the sensor node on the basis of subscription. The relay server receives the subscription from the user equipment, authenticates the user equipment, determines whether a corresponding sensor node is available, and respectively transmits corresponding results to the user equipment and the sensor node such that the sensor node can transmit information to the user equipment.

Upon receiving information from the relay server, the sensor node may check whether the relay server is valid and transmit collected information to the user equipment on the basis of information on the user equipment, which is included in the information received from the relay server, when the relay server is valid.

According to one aspect of the present invention, there is provided a relay server of a system for authentication management of a sensor node having a subscription processing function, the relay server including a sensor node management module, a user information management module, an information transmission and reception module, and a server controller. The sensor node management module stores and manages information representing whether the sensor node is available and address information of the sensor node and updating address information changed as the sensor node moves. The user information management module stores and manages information and address information of a user equipment having a valid permission. The information transmission and reception module transmits and receives information necessary for the user equipment and the sensor node. The server controller signals the address information of the user equipment to the sensor node and signals the address information of the sensor node to the user equipment such that the sensor node transmits collected information to the user equipment, upon receiving subscription information of the user equipment having a valid permission, on the basis of the sensor node management module and the user information management module.

When the sensor node that the user equipment wants to use is not available, the server controller may control information indicating that the sensor node is not available to be transmitted to the user equipment. When the user equipment has not acquired a valid permission, the server controller may control information indicating that the user equipment has not acquired a valid permission to be transmitted to the user equipment.

According to another aspect of the present invention, there is provided a method for operating a system for authentication management of a sensor node having a subscription processing function, the method including: a relay server receiving subscription information from a user equipment; the relay server checking permission validity of the user equipment; the relay server transmitting the subscription information to the sensor node and transmitting subscription acceptance information to the user equipment when the user equipment has a valid permission; the sensor node transmitting collected information stored therein to the user equipment.

The method may further includes, when the address of the sensor node is changed, the relay server receiving information on the changed address from the sensor node; the relay server updating the information of the sensor node; and the relay server transmitting the changed address information to the user equipment.

The subscription information transmitted to the sensor node may include IP address and port information of the user equipment, and the subscription acceptance information transmitted to the user equipment may include IP address and port information of the sensor node.

The method may further includes the relay server checking whether the sensor node is available; and the relay server transmitting information indicating that the sensor node is not available to the user equipment when the sensor node is not available.

The method may further include the relay server transmitting information indicating permission invalidity of the user equipment to the user equipment when the permission of the user equipment is not valid.

In the method for operating the system according to an aspect of the present invention, when the sensor node receives subscription information of a specific user equipment from the relay server while communicating with the relay server in the collected information transmission step, the sensor node may transmit collected information to the user equipment.

According to another aspect of the present invention, there is provided a method for operating a sensor node having a subscription processing function, the method including: the sensor node receiving information from a relay server; the sensor node checking whether the relay server is valid; and the sensor node transmitting collected information to a user equipment on the basis of information on the user equipment, which is included in the information received from the relay server, when the relay server is valid.

The sensor node may ignore the received information when the relay server is not valid.

### Advantageous Effects

According to the system for authentication management of a sensor node having a subscription processing function and a method for operating the system, upon receiving information about a sensor node allocated with an IP address, any direct access of an unauthorized user equipment to the sensor node is blocked and the security of the sensor node is strengthened.

Furthermore, the sensor node is designed such that the sensor node cannot transmit/receive management information to/from any device other than the relay server and provides information only to a user equipment signaled by the relay server, and thus indiscreet access of other user equipments can be blocked.

In addition, since the relay server manages the information on the sensor node, a user can be informed whether the user can access the sensor node within a short period of time and receive information from the sensor node.

### DESCRIPTION OF THE DRAWING

FIG. 1 illustrates a configuration of a system for authentication management of a sensor node having a subscription processing function according to an embodiment of the present invention;

FIG. 2 is a block diagram illustrating a configuration of a relay server according to an embodiment of the present invention;

FIG. 3 illustrates signal transmission/reception of the system for authentication management of the sensor node having the subscription processing function according to an embodiment of the present invention;

FIG. 4 is a flowchart illustrating a method for operating the relay server according to an embodiment of the present invention;

FIG. 5 is a flowchart illustrating a method for operating the system for authentication management of the sensor node having the subscription processing function according to an embodiment of the present invention; and

FIG. 6 is a flowchart illustrating a method for operating a user equipment according to an embodiment of the present invention.

### MODE FOR CARRYING OUT THE INVENTION

Now, the above and other aspects of the present invention will be described in detail through preferred embodiments with reference to the accompanying drawings. In the following description of the present invention, a detailed description of known functions and configurations incorporated herein will be omitted when it may obscure the subject matter of the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings. Although exemplary aspects of the present invention have been described for illustrative purposes, those skilled in the art will appreciate that various modifications, additions and substitutions are possible, without departing from essential characteristics of the invention. Thus, embodiments disclosed herein are exemplary only and not to be considered as a limitation of the invention. Accordingly, the scope of the invention is not to be limited by the above aspects but by the claims and the equivalents thereof.

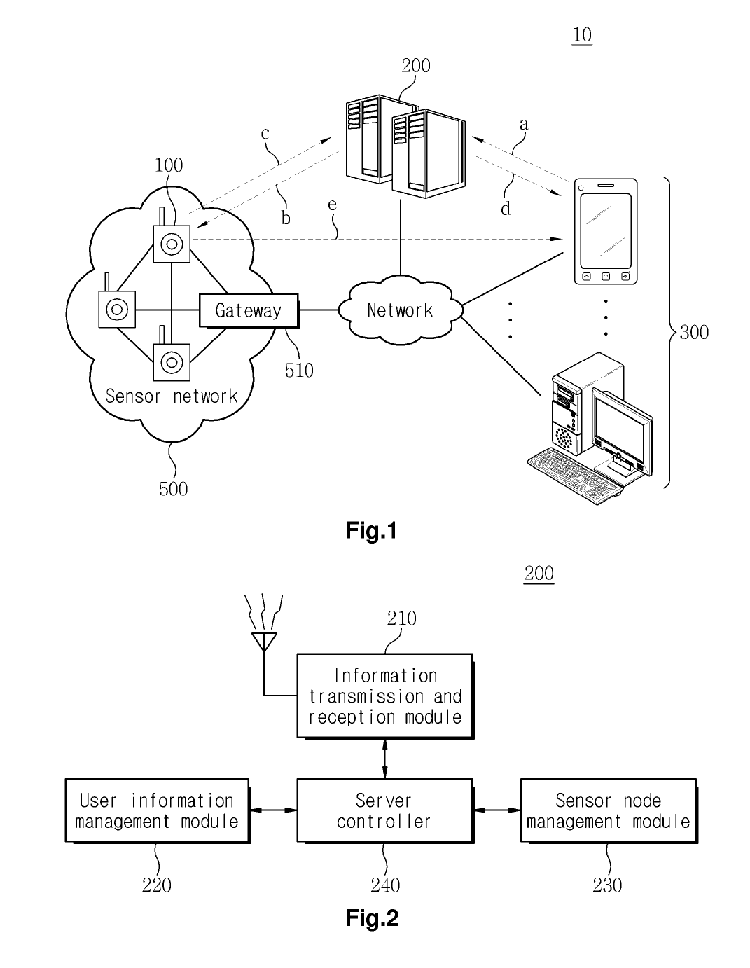

FIG. 1 illustrates a configuration of a system for authentication management of a sensor node having a subscription processing function according to an embodiment of the present invention.

Referring to FIG. 1, the system 10 for authentication management of a sensor node having a subscription processing function according to an embodiment of the present invention may include at least one sensor node 100, a relay server 200 and at least one user equipment 300. The at least one sensor node 100 may include various sensors or tags, form a sensor network 500 and be linked to a network 400 through a gateway 510. When the user equipment 300 logs in the relay server 200 and transmits subscription information on the sensor node 100 to the relay server 200 (a), the relay server 200 checks permission validity for subscription requested by the user equipment 300, checks whether the sensor node 100 can provide a corresponding service when the user equipment has valid permission, finds the sensor node 100 and provides the subscription information to the sensor node 100 (b). One or more sensor nodes 100 can communicate with the relay server 200, receive information on one or more authenticated user equipments 300 registered in the relay server 200 from the relay server 200 and provides services to the one or more equipments 300 (c). In addition, the relay server 200 transmits information representing that subscription has been authenticated to the user equipment 300 (d) and the sensor node 100 transmits information to the user equipment 300 (e).

While a plurality of sensor nodes can be present such that one or more sensor nodes are distributed in various places and positions to sense surrounding environments and collect sensed information, the following description is focused on one sensor node 100 for convenience. In addition, while a plurality of user equipments 300 that access the sensor node 100 to receive information can be present to receive necessary collected information from a specific sensor node, one user equipment 300 will be described in the following.

The system 10 performs information transmission/reception between components thereof through the network 400. Here, the network 400 is operated on the basis of IP address and may include various network components, for example, a wired/wireless access point, a router, an address converter, etc. Accordingly, the network 400 can provide devices to which the components of the system 10, that is, the sensor node 100, the relay server 200 and the user equipment 300 can be connected in a wired or wireless manner.

In The system 10 having the above-mentioned configuration, the sensor node 100 is registered in the relay server 200 to acquire permission to communicate with the user equipment 300 from the relay server 200 and communicates with the user equipment 300 to transmit collected information to the user equipment 300. The user equipment 300 can access the relay server 200 without directly accessing the sensor node 100 to be authenticated and authorized, and then receive necessary collected information from the sensor node 100. Accordingly, the system 10 can block indiscreet access of the user equipment 300 to the sensor node 100 and support rapid and stable access of the user equipment 300 to the sensor node 100. A description will be given of each component of the system in more detail.

The sensor node 100 may include a sensor, a communication module, a storage unit and a controller and collect information using the sensor according to predetermined schedule information. The sensor node 100 may store the collected information in the storage unit and transmit the collected information to the user equipment 300 according to information subscription of the user equipment 300 under the control of the controller. Here, the sensor node 100 can receive information on the specific user equipment 300 from the relay server 200. That is, upon receiving information subscription of the user equipment 300 from the relay server 200, the sensor node 200 can transmit collected information to the user equipment 300 on the basis of IP address information and port information of the user equipment 300 because the information subscription includes the IP addition information and port information of the user equipment 300 that transmits the information subscription. In this case, the sensor node 100 can transmit the collected information to the user equipment 300 at a predetermined interval or transmit desired information, for example, collected temperature information, at an interval of one hour to the user equipment 300. Since authorization management is performed by the relay server 200, the relay server 200 can send authentication end information to the sensor node 100 such that the sensor node stops providing information when determining that authentication needs to be ended. Upon receiving subscription information of the specific user equipment 300 from the relay server 200, the sensor node 100 may selectively transmit collected information for a time corresponding to a transmission period that is set on the basis of the time when the information is received. If authorization of the user equipment 300 needs to be changed for various reasons during transmission of the collected information, the aforementioned collected information transmission limiting function may be selectively executed and the information transmission period or transmission available time may be adjusted. In this manner, the sensor node 100 can perform communication with the relay server 200 and the user equipment 300 designated by the relay server 200. The sensor node 100 can store information on permission of the user equipment 300. In this case, if the user equipment 300 transmits subscription information to the relay server 200, the relay server 200 inquires of the sensor node 100 about permission of the user equipment. Then, the sensor node 100 can transmit, to the relay node 200, information on authorization of the user equipment 300 that currently attempts to access the sensor node on the basis of previously stored information on the user equipment 300. Here, for authorization of the user equipment 300, user equipment information may be stored in the relay server 200 and managed.

The relay server 200 is located between the sensor node 100 and the user equipment 300. Upon receiving information subscription from the user equipment 300, the relay server 200 can perform authentication and authorization of the user equipment 300. In addition, the relay server 200 can deliver the information subscription of the user equipment 300 to the sensor node 100. To achieve this, the relay server 200 may include a configuration for management of the sensor node 100 and the user equipment 300. The detailed configuration of the relay server 200 will be described in detail below with reference to FIG. 2.

The user equipment 300 may include a communication module, an input unit, an output unit, a storage unit and a controller, transmit subscription information to the relay server 200 and receive collected information from the sensor node 100 using the communication module. The user equipment 300 can generate an input signal corresponding to user input on the basis of the input unit. The output unit of the user equipment 300 may include a display unit for displaying information or images, an audio processor for outputting an audio signal, etc., a vibration unit for generating vibration, etc. The output unit of the user equipment 300 can output various types of information about access of the relay server 200, authentication and authorization and output information about access of the sensor node 100 and collected information. The storage unit can store the collected information received from the sensor node 100 temporally or semi-permanently. The controller can control the above-mentioned components to generate subscription information when a user wants to receive collected information from the specific sensor node 100, to transmit the subscription information to the relay server 200, to output information about authentication and authorization when the user equipment 300 is authenticated and authorized by the relay server 200, to receive collected information from the sensor node 100, and to output the received collected information. If the user equipment 300 is not authenticated and authorized by the relay server 200, the controller can control an alarm representing that the user equipment 300 is not authenticated and authorized to be output. The operation of the user equipment 300 will be described in more detail with reference to the attached drawings. Here, the user equipment is a communication terminal that can be linked to the network 400. While the user equipment includes a personal computer, a notebook computer, a cellular phone, a smartphone, etc., it is not limited thereto.

FIG. 2 is a block diagram illustrating the configuration of the relay server according to an embodiment of the present invention.

Referring to FIG. 2, the relay server 200 may include an information transmission/reception module 210, a user information management module 220, a sensor node management module 230 and a server controller 240.

The relay server 200 having the above-mentioned configuration can communicate with the user equipment 300 and the sensor node 100 to control authorization of information subscription of the user equipment 300 and transmission of collected information between the authorized user terminal 300 and the sensor node 100.

The information transmission/reception module 210 receives subscription information from the user equipment 300 and transmits the subscription information to the server controller 240. The information transmission/reception module 210 transmits the subscription information to the sensor node 100. The information transmission/reception module 210 is an IP-based data transmitting/receiving module which can transmit data to the network 400 to which the user equipment 300 and the sensor node 100 are linked and receive data from the network 400.

The user information management module 220 stores and manages information on the user equipment 300 capable of receiving collected information of the specific sensor node 100. Provided that a plurality of sensor nodes 100 and a plurality of user equipments 300 are present, the user information management module 220 can store information about sensor nodes from which each authorized user equipment 300 can receive collected information. This information can be stored and managed according to previous registration of the user equipment 300. When the user equipment 300 attempts to use information of a specific sensor node 100, the relay server 200 can request the user equipment 300 to provide information necessary to use the specific sensor node 100 and authorize the user equipment 300 to receive the information of the sensor node 100 when the user equipment 300 provides appropriate information. The relay server 200 can authenticate the user equipment 300 on the basis of information stored in the user information management module 220.

The sensor node management module 230 stores and manages various types of sensor node information. The sensor node management module 230 stores and manages IP address information and accessible port information of each sensor node 100. When the IP address information and port information of the sensor node 100 are changed as the sensor node 100 moves, the sensor node management module 230 can update the information. The sensor node management module 230 can periodically perform a procedure of checking whether each sensor node 300 is currently available. In addition, the sensor node management module 230 can check whether the specific sensor node 100 is available upon receiving subscription information for requesting information collection of the sensor node 100 from the user equipment 300. For example, the sensor node management module 230 can transmit, to the sensor node 100, information that inquires about whether the specific sensor node 100 is available and determine that the sensor node 100 is available upon receiving response information from the sensor node 100 within a predetermined time.

The sever controller 240 controls the aforementioned components such that collected information of the sensor node 100 can be transmitted only to the authorized user equipment 300.

The server controller 240 can use the user information management module 220 to check information on the user equipment 300. When the user equipment 300 is an authenticated terminal, the server controller 240 can control information, which signals that the sensor node 100 can provide information, to be transmitted to the user equipment 300. The server controller 240 can transmit the subscription information to the specific sensor node 100. Upon receiving the subscription information, the sensor node 100 can perform transmission to the user equipment 300 on the basis of the IP address and port information of the user equipment 300, which are included in the received subscription information. In this case, the server controller 240 can embed information, which limits transmission to the user equipment 300 to a predetermined number of transmissions or transmission for a predetermined time, in the subscription information transmitted to the sensor node 100. Accordingly, the sensor node 100 can perform only the predetermined number of transmissions to the authenticated user equipment 300 or perform transmission to the user equipment 300 only for the predetermined time, and thus the transmission period or time of collected information may be restricted.

Upon determining that the user equipment 300 is an unregistered terminal, the server controller 240 can transmit information indicating that the user equipment 300 is an unregistered terminal to the user equipment 300. Upon receiving the information indicating that the user equipment 300 is an unregistered terminal from the relay server 200, the user equipment 300 can output the information. In addition, the server controller 240 can check activation and communication state of the sensor node 100 that the user equipment 300 attempts to use and, when the sensor node 100 is not available, transmit information indicating that the sensor node 100 is not available to the user equipment 300.

As described above, the system 100 according to the embodiments of the present invention can check whether the user equipment 300 can access the specific sensor node 100 by checking information on the user equipment 300 and control only the authorized user equipment 300 to receive information service from the sensor node 100. Furthermore, the system 10 can collect and manage information on the sensor nodes 300 and check which sensor node is currently available. In addition, the system 10 can update access information as the sensor nodes 100 move such that the user equipment 300 can find a desired sensor node rapidly and easily.

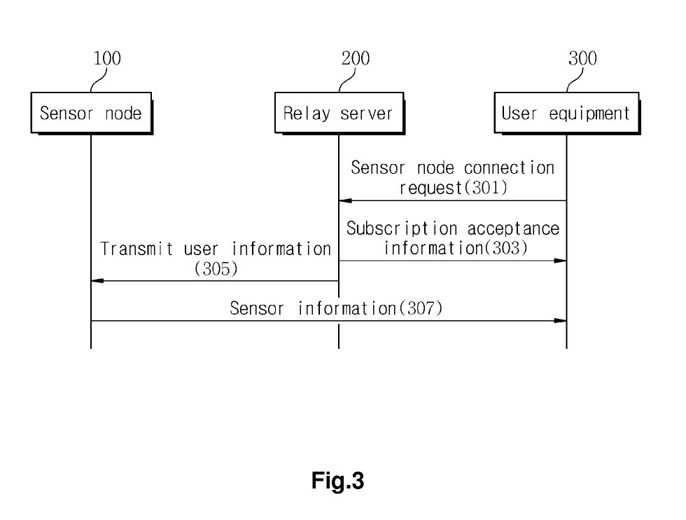

FIG. 3 illustrates signals transmitted and received during a sensor node information collecting procedure.

Referring to FIG. 3, the user equipment 300 can transmit sensor node connection request information to the relay server 200 under the control of the user in step 301. The sensor node connection request information may be subscription information for requesting a specific sensor node 100 to provide collected information.

Upon receiving the sensor node connection request information from the user equipment 300, the relay server 200 can transmit subscription acceptance information to the user equipment 300 in step 303. To achieve this, the user equipment 300 needs to be authorized to access the specific sensor node 100 in advance. The relay server 200 can check whether the user equipment 300 has permission to access the specific sensor node 100 by checking information on the user equipment 300. Through this authentication procedure, the relay server 200 can transmit the subscription acceptance information to the user equipment 300, as described above, when the user equipment 300 has permission to access the sensor node 100. The subscription acceptance information may include the IP address and port information of the sensor node 100. The information may be excluded from the subscription acceptance information according to a designer.

After transmitting the subscription acceptance information to the user equipment 300, the relay server 200 can transmit the information on the user equipment 300 to the sensor node 100 in step 305. The information on the user equipment 300 may include the IP address and port information of the user equipment 300 such that the sensor node 100 can transmit collected information to the user equipment 300 on the basis of the IP address and port information of the user equipment 300. The relay server 200 can include information that designates the number of communications with the user equipment 300 or communication available time, in the information on the user equipment 300, and transmit the user equipment information including the information. Then, the sensor node 100 may perform communication with the user equipment 300 having the ID address and port information only by the number of communications or only for the communication available time included in the received user equipment information and may not respond to access of the user equipment 300 after the communication. Accordingly, the relay server 200 can prevent the user equipment 300 from indiscreetly accessing the sensor node 100. The system 10 may be designed such that the sensor node 100 sets the number of communications and communication available time even if the relay server 200 does not transmit the information including the number of communications and communication available time. That is, upon receiving user information for communication with the specific user equipment 300 from the relay server 200, the sensor node 100 can perform only a predetermined number of communications with the user equipment 300 or perform communication with the user equipment 300 only for a communication available time. In this case, the predetermined number of communications and the communication available time may be changed according to the designer of the sensor node 100 or under the control of the relay server 200.

Upon receiving the information on the user equipment from the relay server 200, the sensor node 100 can transmit collected sensor information to the user equipment 300 in step 307. Here, the sensor node 100 can search for the user equipment 300 corresponding to the IP address and port information, which are included in the information on the user equipment, and transmit information requested by the user equipment 300 through the user information to the user equipment 300.

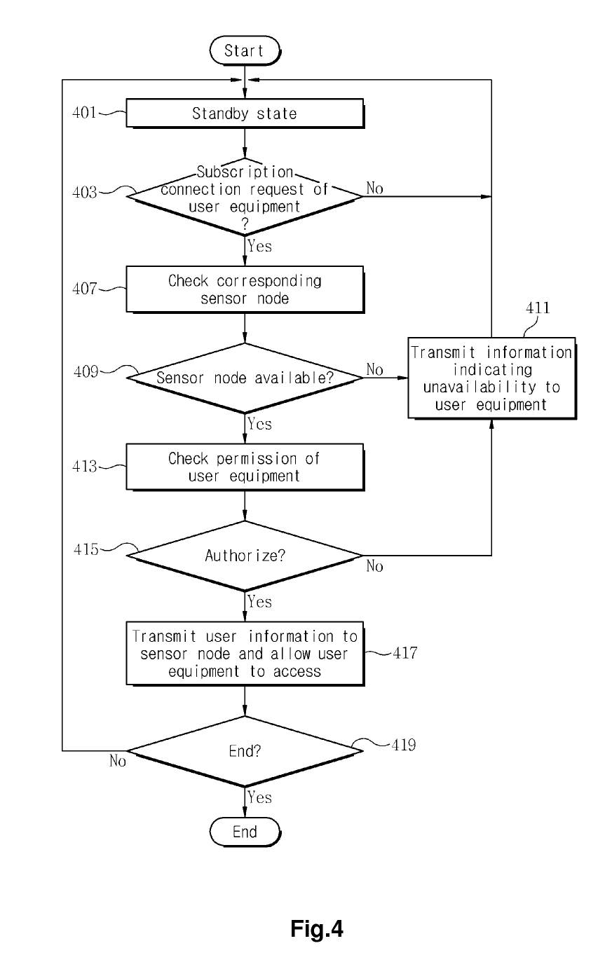

FIG. 4 is a flowchart illustrating a method for operating the relay server in the system for authentication management of a sensor node having a subscription processing function according to an embodiment of the present invention.

Referring to FIG. 4, the method for operating the relay server can perform device initialization on the basis of supplied power and maintain a standby state in step 401. The relay server 200 can check whether subscription information is received from the specific user equipment 300 in step 403. When the subscription information is not received, step 403 is branched to the procedure before step 401 and the relay server repeats steps 401 and 403.

When the subscription information is received from the user equipment 300 in step 403, step 403 is branched to step 407 in which relay server 200 checks a sensor node indicated by the subscription information. To achieve this, the relay server 200 can check whether the sensor node 100 is available in step 409 with reference to sensor node information collected by the sensor node management module 230, or inquire availability of the corresponding sensor node 110 in the current step, that is, capacity of the sensor node 100, on the basis of the IP address and port information of the sensor node 100.

When the sensor node 100 is not available in step 409, step 409 is branched to step 411 in which the relay server 200 can transmit information representing that the sensor node is not available to the user equipment 300. Then, the relay server 200 returns to the procedure before step 401 and performs the steps 401 to 409. When the sensor node 100 is available in step 409, the relay server 200 checks permission of the user equipment 300 in step 413. To achieve this, the relay server 200 check whether the user equipment 300 has a permission to receive information collected by the sensor node 100 with reference to the user information management module 220 in step 415. Information about access permission can be generated when the user equipment 300 acquires a permission to access the sensor node 100 through various paths and performs registration in the relay server. The various paths may include routes through which a user who operates the user equipment 300 registers the user equipment 300 in the relay server 200 that manages the sensor node 100 through an online or offline access connecting part.

When access permission of the user equipment 300 is not valid in step 415, step 415 is branched to step 411 in which the relay server 200 can transmit information representing that the sensor node 100 is not available to the user equipment 300 in step 411. Here, information transmitted in step 411 branched from step 409 may differ from information transmitted in step 411 branched from step 415. That is, the relay server 200 can transmit information indicating that the sensor node 100 is not available due to a defect of the sensor node 100 when step 411 is branched from step 409 and transmit information representing that the user equipment 300 has not acquired access permission or has no access permission to the user equipment 300 when step 411 is branched from step 415.

When it is determined that the user equipment 300 has access permission in step 415, the relay server can transmit user information to the sensor node 100 and transmit subscription acceptance information to the user equipment 300 in step 417. Then, the relay server 200 checks whether operation of the relay server 200 is ended in step 419 and, when a signal for ending the operation of the relay server is not generated, step 419 is branched to the procedure before step 401 and the relay server 200 repeats steps 401 to 419.

While the relay server 200 checks whether the sensor node 100 is available first and then checks permission validity of the user equipment 300 in the above description, the present invention is not limited thereto. That is, in the method for operating the relay server 200, steps 413 and 415 for checking permission validity of the user equipment 300 may precede steps 407 and 409.

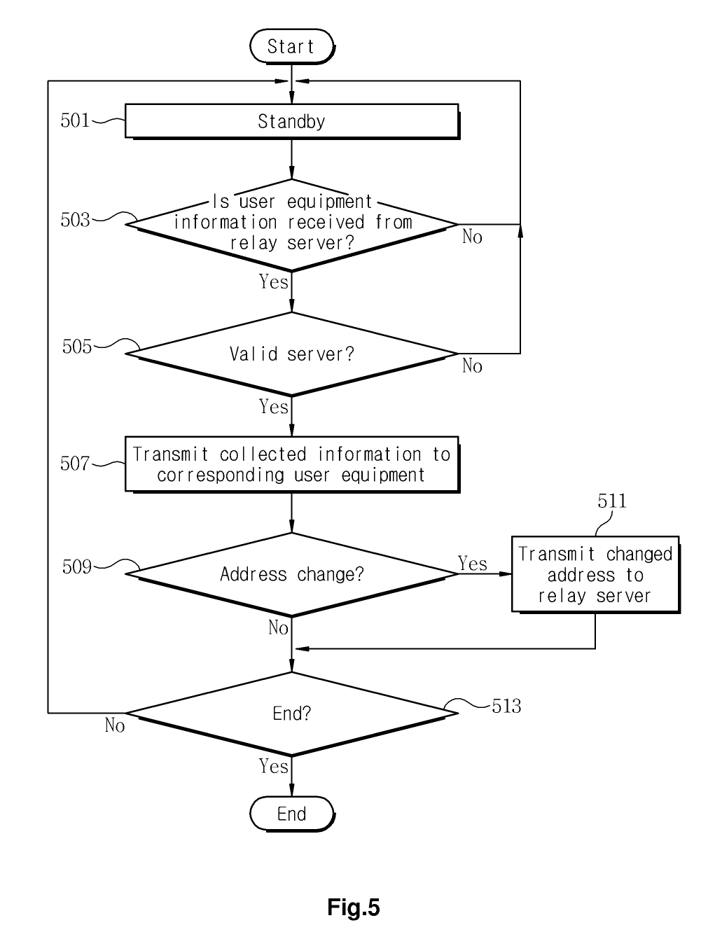

FIG. 5 is a flowchart illustrating a method for operating the system for authentication management of the sensor node 100 having the subscription processing function according to an embodiment of the present invention.

Referring to FIG. 5, when power is supplied, initialization is performed and a standby state is maintained in step 501. The sensor node 100 can collect various types of information about the surrounding environment according to predetermined schedule information in the standby state. Here, the sensor node 100 collects and stores sensor values of one or more sensors included therein.

Then, the sensor node 100 checks whether information is received from the relay server 200 in step 503. When no information is received, step 503 is branched to the procedure before step 501 and the sensor node 100 performs steps 501 and 503.

When information is received in step 503, the sensor node 100 checks whether the information is received from the valid relay server 200 in step 505. That is, the sensor node 100 stores information on the relay server 200 that can communicate with the sensor node 100 and thus, when information is received from an arbitrary relay server, the sensor node 100 checks whether the relay server is a valid relay server.

When it is determined that the information is not received from the valid relay server 200 in step 505, the sensor node 100 ignores the received information, step 505 is branched to the procedure before step 501 and the sensor node 100 performs steps 501 to 505. That is, the sensor node 100 does not process the received information.

When it is determined that the information is received from the valid relay server 200 in step 505, the sensor node 100 processes the received information in step 507. Here, the information received from the valid relay server 200 may be information about the user equipment 300.

When information on the user equipment 300 is received from the valid relay server 200 in step 503, step 503 is branched to step 507 in which the sensor node 100 transmits collected information to the user equipment 300. Here, the sensor node 100 can extract IP address and port information by which the sensor node 100 can communicate with the user equipment 300 from the information on the user equipment 300 and transmit the collected information to the user equipment 300 on the basis of the extracted IP address and port information. The sensor node 100 can check whether the address thereof is changed in step 509. When it is determined the address is changed in step 509, step 509 is branched to step 511 in which the sensor node 100 can transmit information on the changed address to the relay server 200. The address may be changed when the sensor node 100 moves and thus the IP address thereof is varied. When it is determined that the address is not changed in step 509, it is checked whether the sensor node 100 is ended in step 513 and, when a signal for ending the sensor node is not input, step 513 is branched to the procedure before step 501 and steps 501 to 513 are repeated.

While steps 501 to 507, step 509 and step 511 are described in a unified manner in the above, steps 501 to 507 and steps 509 and 511 may be independently performed. Accordingly, the method for operating the sensor node 100 should be understood as the two procedures which can be independently performed.

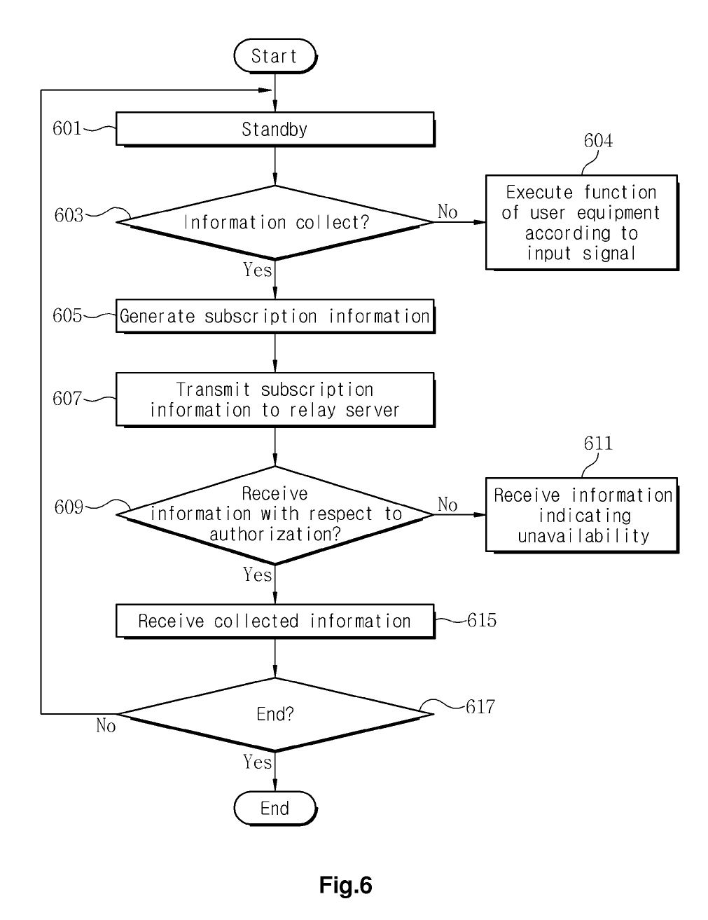

FIG. 6 is a flowchart illustrating a method for operating the user equipment 300 according to an embodiment of the present invention.

Referring to FIG. 6, the method for operating the user equipment 300 initializes components of the user equipment 300 when power is supplied to the user equipment 300. Upon completion of initialization, a standby state can be maintained in step 601. During this procedure, the user equipment 300 may display a standby screen or a menu screen according to predetermined schedule information.

Upon generation of an input signal in step 603, the user equipment 300 checks whether the input signal is a signal for requesting information collection of the sensor node 100. When the input signal generated in step 603 is not a signal for requesting information collection, step 603 is branched to step 604 in which execution of a function of the user equipment 300 is controlled according to the input signal. When the input signal generated in step 603 is a signal for requesting information collection of the sensor node 100, the user equipment 300 can generate subscription information in step 605 and transmit the subscription information to the relay server 200 in step 607. To achieve this, the user equipment 300 can previously collect and store IP address and port information for accessing the relay server 200.

The user equipment 300 can check whether information with respect to authorization is received from the relay server 200 in step 609. If the user equipment 300 has not acquired permission or the corresponding sensor node 100 is not available, the user equipment 300 can receive information indicating that the sensor node is not available in step 611. The information indicating that the sensor node is not available may vary according to whether the sensor node 100 is available and whether permission of the user equipment 300 is valid. Upon receiving the information indicating that the sensor node is not available, the user equipment 300 can output the information through a display such that the user can recognize the information.

When the user equipment 300 receives information with respect to authorization, for example, subscription acceptance information, from the relay server 200 in step 609, the user equipment 300 can receive collected information from the corresponding sensor node 100 in step 615. Here, the user equipment 300 can extract IP address and port information of the sensor node 100 from the subscription acceptance information and, when the sensor node transmits information, check whether the information is transmitted from the sensor node using the extracted information. To achieve this, the relay server 200 can include the IP address and port information of the sensor node 100 in the subscription acceptance information and transmit the subscription acceptance information to the user equipment 300.

Then, it is checked whether the operation of the user equipment 300 is ended in step 617 and, when an input signal for ending the user equipment 300 is not generated, step 617 is branched to the procedure before step 601 and steps 601 to 617 can be repeated.

As described above, the method for operating the system according to an embodiment of the present invention can control the user equipment 300 to access the sensor node 100 via the relay server 200 so as to prevent indiscreet access of the user equipment 300 to the sensor node 100 and to allow only an authorized user equipment to access the sensor node. Furthermore, according to the present invention, the relay server 200 manages the sensor node 100 such that the user equipment 300 can easily search and check the state or location of the sensor node 100 that the user equipment 300 wants to use.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A system for authentication management of a sensor node having a subscription processing function, the system comprising:
a sensor node for collecting information using a sensor;
a user equipment for receiving information from the sensor node on the basis of subscription; and
a relay server for receiving the subscription from the user equipment, authenticating the user equipment, determining whether a corresponding sensor node is available, and respectively transmitting corresponding results to the user equipment and the sensor node such that the sensor node transmits information to the user equipment.

2. The system of claim 1, wherein, upon receiving information from the relay server, the sensor node checks whether the relay server is valid and transmits collected information to the user equipment on the basis of information on the user equipment, which is included in the information received from the relay server, when the relay server is valid.

3. A relay server of a system for authentication management of a sensor node having a subscription processing function, the relay server comprising:
a sensor node management module for storing and managing information representing whether the sensor node is available and address information of the sensor node and updating address information changed as the sensor node moves;
a user information management module for storing and managing information and address information of a user equipment having valid permission;
an information transmission and reception module for transmitting and receiving information necessary for the user equipment and the sensor node; and
a server controller for signaling the address information of the user equipment to the sensor node and signaling the address information of the sensor node to the user equipment such that the sensor node transmits collected information to the user equipment, upon receiving subscription information of the user equipment having a valid permission, on the basis of the sensor node management module and the user information management module.

4. The relay server of claim 3, wherein, when the sensor node that the user equipment wants to use is not available, the server controller controls information indicating that the sensor node is not available to be transmitted to the user equipment.

5. The relay server of claim 3, wherein, when the user equipment has not acquired a valid permission, the server controller controls information indicating that the user equipment has not acquired a valid permission to be transmitted to the user equipment.

6. A method for operating a system for authentication management of a sensor node having a subscription processing function, the method comprising:
a relay server receiving subscription information from a user equipment;
the relay server checking permission validity of the user equipment;
the relay server transmitting the subscription information to the sensor node and transmitting subscription acceptance information to the user equipment when the user equipment has a valid permission;
the sensor node transmitting collected information stored therein to the user equipment.

7. The method of claim 6, further comprising:
when the address of the sensor node is changed, the relay server receiving information on the changed address from the sensor node;
the relay server updating the information of the sensor node; and
the relay server transmitting the changed address information to the user equipment.

8. The method of claim 6, wherein the subscription information transmitted to the sensor node includes IP address and port information of the user equipment, and the subscription acceptance information transmitted to the user equipment includes IP address and port information of the sensor node.

9. The method of claim 6, further comprising:
the relay server checking whether the sensor node is available; and
the relay server transmitting information indicating that the sensor node is not available to the user equipment when the sensor node is not available.

10. The method of claim 6, further comprising the relay server transmitting information indicating permission invalidity of the user equipment to the user equipment when the permission of the user equipment is not valid.

11. A method for operating a sensor node having a subscription processing function, the method comprising:
the sensor node receiving information from a relay server;
the sensor node checking whether the relay server is valid; and
the sensor node transmitting collected information to a user equipment on the basis of information on the user equipment, which is included in the information received from the relay server, when the relay server is valid.

12. The method of claim 11, wherein the sensor node ignores the received information when the relay server is not valid.
